(19) United States
(12) Patent Application Publication
(10) Pub. No.: US 2022/0176177 A1
(43) Pub. Date: Jun. 9, 2022

(54) ADJUSTABLE NOZZLE AND METHOD OF OPERATION

(71) Applicant: HEN Nozzles Inc., Castro Valley, CA (US)

(72) Inventors: Sunny SETHI, Castro Valley, CA (US); Nicholas J. MCKIBBEN, Oakland, CA (US)

(21) Appl. No.: 17/569,821

(22) Filed: Jan. 6, 2022

Related U.S. Application Data
(63) Continuation-in-part of application No. 17/112,993, filed on Dec. 5, 2020.
Application No. 17/112,993 is a continuation-in-part of application No. 16/595,218, filed on Oct. 7, 2019.
Application No. 16/595,218 is a continuation-in-part of application No. 17/112,990, filed on Dec. 5, 2020.
Application No. 17/112,990 is a continuation-in-part of application No. 16/595,218, filed on Oct. 7, 2019.
Application No. 16/595,218 is a continuation-in-part of application No. PCT/US2021/038393, filed on Jun. 22, 2021.
Application No. PCT/US2021/038393 is a continuation of application No. 17/112,993, filed on Dec. 5, 2020.
Application No. 17/112,990 is a continuation-in-part of application No. 16/595,218, filed on Oct. 7, 2019.
Application No. PCT/US2021/038393 is a continuation of application No. 17/112,990, filed on Dec. 5, 2020.
(60) Provisional application No. 62/880,567, filed on Jul. 30, 2019.
(60) Provisional application No. 62/880,567, filed on Jul. 30, 2019.
(60) Provisional application No. 62/880,567, filed on Jul. 30, 2019.

(51) Int. Cl. A62C 31/03; B05B 1/26; B05B 1/12; B05B 1/06

(52) U.S. Cl. CPC A62C 31/03; B05B 1/06; B05B 1/12; B05B 1/26

(57) ABSTRACT

An adjustable nozzle having a nozzle body having an inlet section with an inlet opening, an outlet section with an outlet opening, and a fluid flow path extending from the inlet opening to the outlet opening; a spray restrictor segment located in the outlet section; and an actuator that displaces the spray restrictor segment toward and away from a center of the fluid flow path, thereby varying a pattern of fluid flowing from the fluid flow path through the outlet opening.

### GOVERNMENT LICENSE RIGHTS

This invention was made with government support under Contract No. 2127461 awarded by The National Science Foundation. The government has certain rights in the invention.

### TECHNICAL FIELD

This disclosure relates to nozzles for spraying fluid under pressure and more particularly to adjustable nozzles that shape the stream of fluid exiting the nozzle.

### BACKGROUND

Nozzles are used to receive a fluid under pressure and control the shape and other characteristics of the stream of the fluid as it exits the nozzle. Such nozzles typically have an inlet opening, an exit opening that may take the form of a single orifice or multiple orifices, and a fluid flow path extending between the inlet opening and the exit opening. The inlet opening may include a fitting for connecting the nozzle to a tank, flexible hose, or pipe. Nozzles frequently are designed to increase the velocity of the fluid entering the nozzle. This is achieved by providing a fluid flow path that decreases in cross-sectional area from the inlet opening to the exit opening and/or includes an orifice in the fluid flow path of reduced cross-sectional area. Providing such a constriction to fluid flow under constant pressure and constant volume flow rate results in the increase in fluid flow velocity. Typically, the outlet orifice itself of the nozzle is reduced in cross-sectional area relative to the fluid flow path and provides the velocity increase.

A desirable feature of nozzles is the ability to vary the velocity of the fluid exiting the nozzle. In some designs, fluid flow velocity and fluid flow rate are varied by providing a plunger in the fluid flow path that is displaceable toward and away from a constricting orifice, which may be the nozzle exit opening. By advancing the plunger toward the constricting orifice, the cross-sectional area of the flow path between the outer periphery of the plunger and the inner periphery of the orifice is varied. This adjusts the velocity of the fluid exiting the nozzle, which increases the distance the stream travels from the nozzle. Other components, such as valves, may be employed to vary the velocity of fluid exiting the nozzle.

Nozzles with a flow path defined by smooth continuous nozzle walls and an absence of internal obstructions provide laminar fluid flow. Laminar fluid flow is desirable because it optimizes fluid flow through the nozzle and provides a uniform spray from the exit opening. A disadvantage with such adjustable designs is that the addition of a plunger, valve, or other flow regulating component in the fluid flow path of the nozzle presents an obstruction to the flow of fluid through the nozzle that causes turbulent fluid flow. Turbulence in fluid flow through nozzles is undesirable in applications in which a spray from the exit opening that is uniform across the width of the exit opening is desired.

Accordingly, there is a need for a nozzle that adjusts the effective cross-sectional area of the exit opening to vary the shape of the fluid stream from the exit opening but that does not present inclusions or obstructions in the fluid flow path through the nozzle. There is also a need for an adjustable nozzle that can provide a flat stream or fluid from its exit opening that can be varied in width easily.

### SUMMARY

The present disclosure describes an adjustable nozzle and the method of its operation that optimizes fluid flow through the nozzle and consequently the throw distance and coverage of the fluid stream, and at the same time can be actuated easily by a user to adjust a width of the stream. The disclosed nozzle provides adjustability of the width of the fluid stream without requiring the presence of plungers, valves, or other components in the fluid flow stream. The fluid flow pathway of the nozzle is smooth and free of obstructions, which promotes laminar fluid flow resulting in a fluid flow stream that is uniform along its width and along its length.

In one embodiment, an adjustable nozzle includes a nozzle body having an inlet section with an inlet opening, an outlet section with an outlet opening, and a fluid flow path extending from the inlet opening to the outlet opening. A spray restrictor segment is located in the outlet section. An actuator displaces the spray restrictor segment toward and away from a center of the fluid flow path, thereby varying a pattern of fluid flowing from the fluid flow path through the outlet opening.

In another embodiment, an adjustable nozzle includes a nozzle body having an inlet section with an inlet opening and an outlet section with an outlet opening, the outlet section having a terminal segment with opposed planar, parallel top and bottom walls and first and second opposed planar side walls contiguous with the top and bottom walls. The top and bottom walls are greater in length than the first and second side walls such that the outlet opening is oblong. A fluid flow path extends from the inlet opening to the outlet opening such that fluid exits the outlet opening in a rectangular stream. First and second opposed spray adjustment arms are attached to the outlet section and are extendable into the fluid flow path. The spray adjustment arms each have a planar body terminating in an upstream cam tab, a downstream cam tab, and a rectilinear edge facing a center of the fluid flow path. The upstream cam tabs are received for pivotal movement of the first and second spray adjustment arms in first and second sockets formed in the first and second side walls, respectively.

An actuator ring is rotatably mounted on an end of the nozzle body, the actuator ring having an elliptical groove concentric with a center of the fluid flow path that receives the downstream cam tabs attached to the spray adjustment arms. Rotation of the actuator ring relative to the end of the nozzle body pivots the spray adjustment arms toward and away from the center of the fluid flow path, thereby varying a width of the rectangular stream of fluid from the outlet opening.

In yet another embodiment, a method of varying a width of an oblong stream of fluid exiting an oblong outlet opening in an outlet section of a nozzle body includes actuating an actuator in the outlet section to displace a spray restrictor segment toward and away from a center of the fluid flow path to vary an effective width of the oblong outlet opening, thereby varying the width of the rectangular stream of fluid exiting the outlet opening.

Other objects and advantages of the disclosed adjustable nozzle and method of operation will be apparent from the following description, the accompanying drawings, and the appended claims.

### BRIEF DESCRIPTION OF THE DRAWINGS

FIG. 1 is a perspective view of an exemplary embodiment of the disclosed adjustable nozzle;

FIG. 2 is an exploded perspective view of the adjustable nozzle of FIG. 1;

FIG. 3 is a top plan view in section of the adjustable nozzle of FIG. 1, showing the spray adjustment arms pivoted by the actuator for maximum fluid spray width;

FIG. 4 is a top plan view in section of the adjustable nozzle of FIG. 1, showing the spray adjustment arms pivoted by the actuator for minimum fluid spray width;

FIG. 5 is a side elevation in section of the adjustable nozzle of FIG. 1;

FIG. 6 is a perspective view of a representative spray adjustment arm;

FIG. 7 is a perspective view of an embodiment of an actuator of the adjustable nozzle of FIG. 1 in the form of an actuator ring; and

FIG. 8 is a side elevation in section of the actuator ring of FIG. 7.

### DETAILED DESCRIPTION

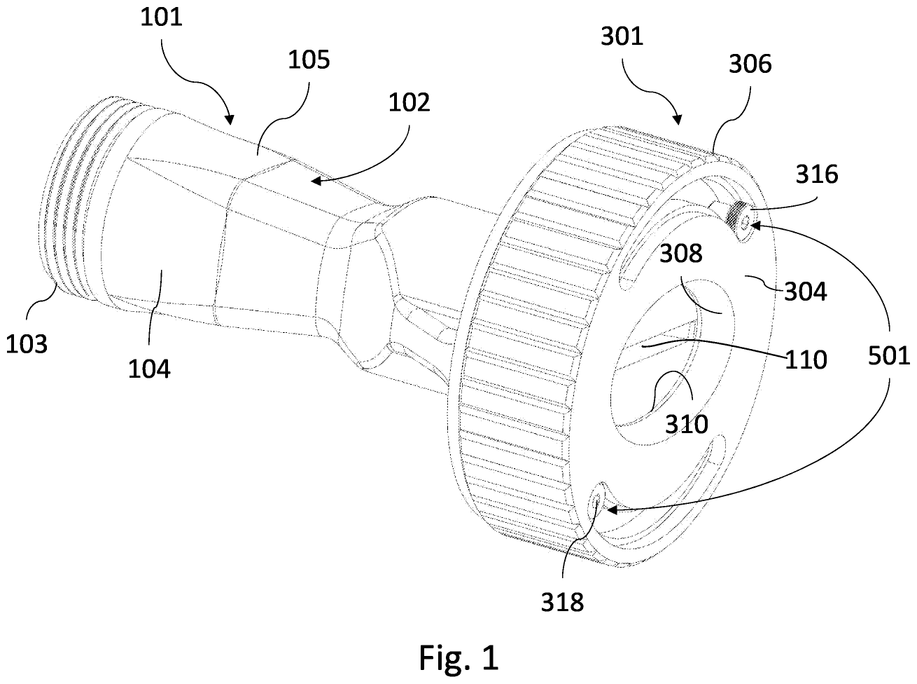

As shown in FIGS. 1, 2, and 3, an exemplary embodiment of the disclosed adjustable nozzle, generally designated 101, includes a nozzle body 102 having an inlet section 104 with an inlet opening 106, an outlet section 108 with an outlet opening 110, and a fluid flow path A extending from the inlet opening to the outlet opening. In embodiments, the inlet section 104 includes a connector 103, which may take the form of a threaded fitting, for connecting the nozzle 101 to a flexible hose (not shown) or other source of fluid, such as water, to be sprayed from the outlet opening 110. In other embodiments, the connector 103 may take the form of a valve or a quick disconnect.

The nozzle 101 also includes a spray restrictor segment 201 is located in the outlet section 108. The nozzle 101 also includes an actuator that in embodiments takes the form of an actuator ring 301 that displaces the spray restrictor segment 201 toward and away from a center of the fluid flow path A, thereby varying a pattern of fluid flowing from the fluid flow path through the outlet opening 110. In other embodiments, the actuator may take the form of a lever. In embodiments, the nozzle 101 is made of a rugged, corrosion-resistant material, such as bronze, brass, aluminum, and stainless steel. The type and thickness of material is determined by the type of fluid sprayed and the fluid pressures encountered by the nozzle. In a particular embodiment, the nozzle 101 is sized to be used in firefighting applications.

In an embodiment, the nozzle body 102 includes a transition segment 105 that defines a segment of the fluid flow path A that transitions in the shape of the inner periphery from a round cross section, adjacent the connector 103, gradually and continuously to an inner periphery forming a square or rectangular cross section. In some embodiments, the cross sectional area of the transition segment gradually and continuously decreases in the direction of the fluid flow path A as the walls defining the fluid flow path converge toward the center of the flow path.

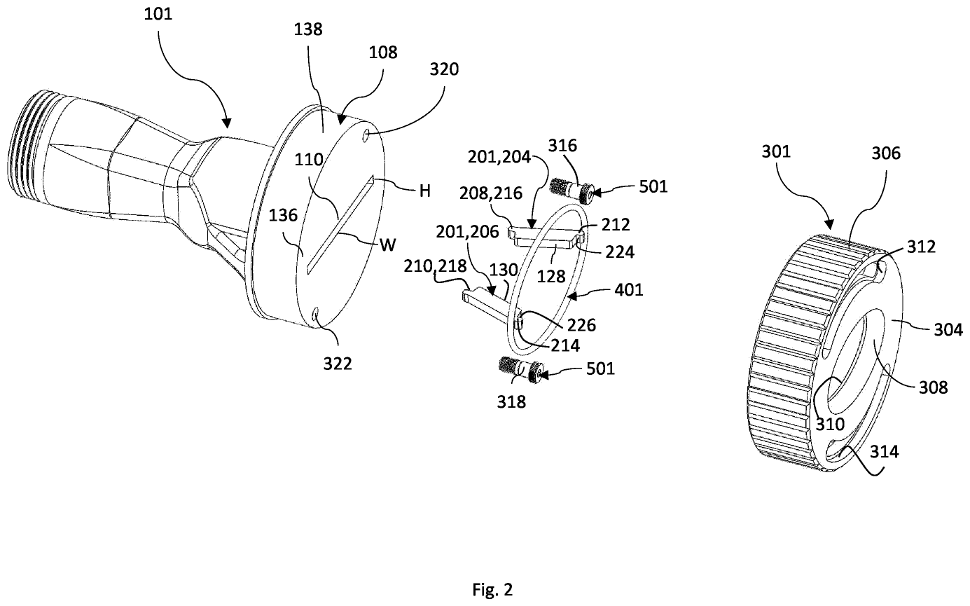

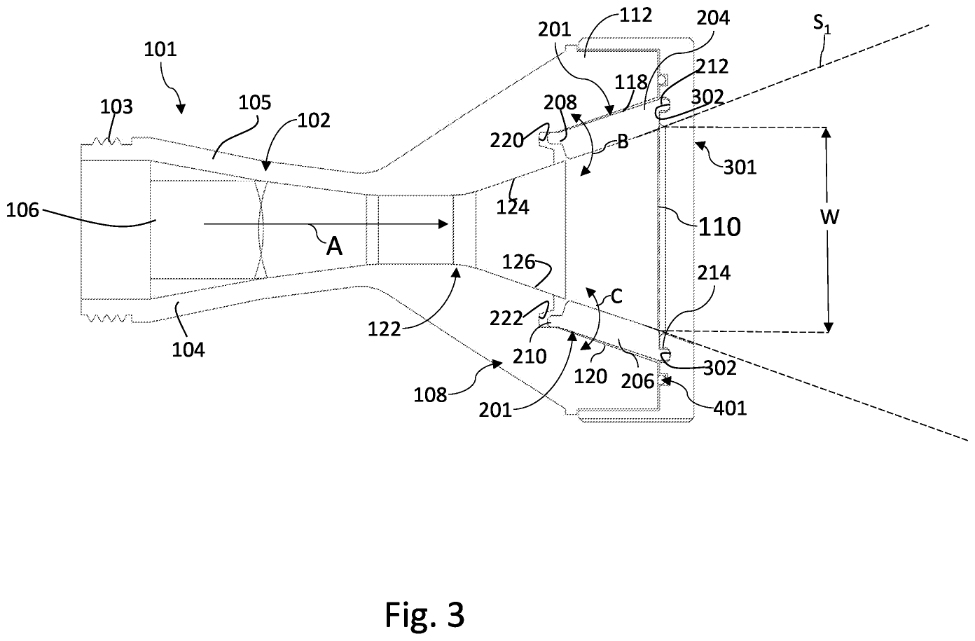

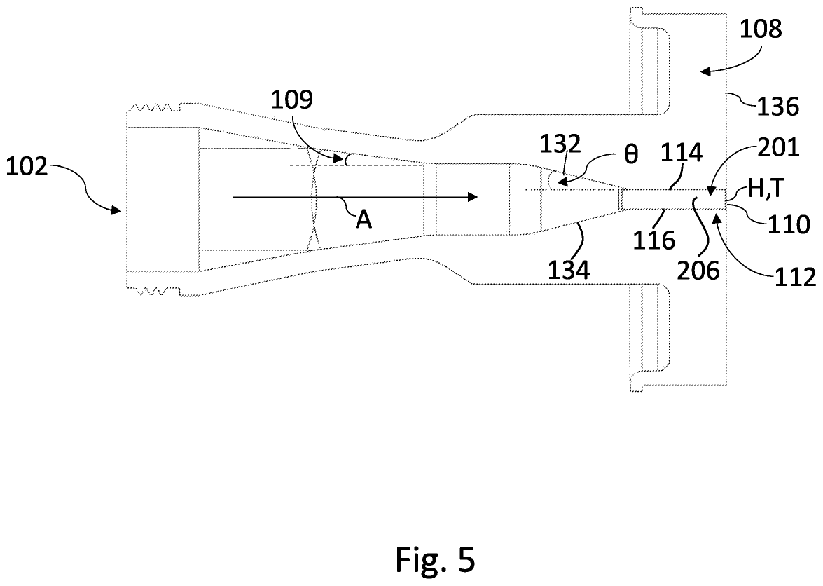

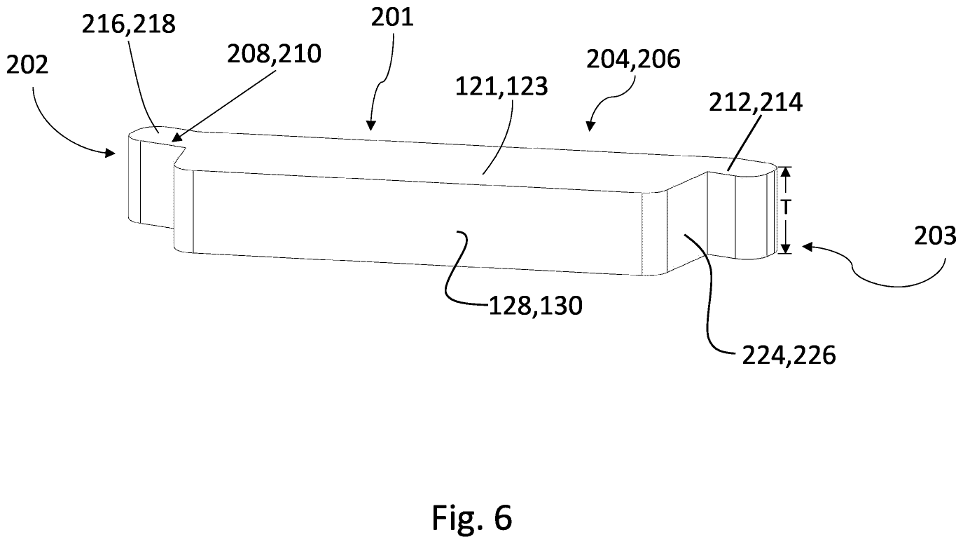

As best shown in FIG. 2, in an embodiment, the outlet opening 110 of the adjustable nozzle 101 is oblong in shape, having a width W and a height H. The actuator ring 301 displaces the spray restrictor segment 201 toward and away from the center of the fluid flow path A (see FIG. 3) to vary the effective width of the outlet opening 110 and thereby control the width of the pattern of fluid spray S₁, S₂ from the outlet opening. In an embodiment, the spray restrictor segment 201 has a thickness T (see FIGS. 5 and 6) that equals, or approximately equals, the height H of the outlet opening.

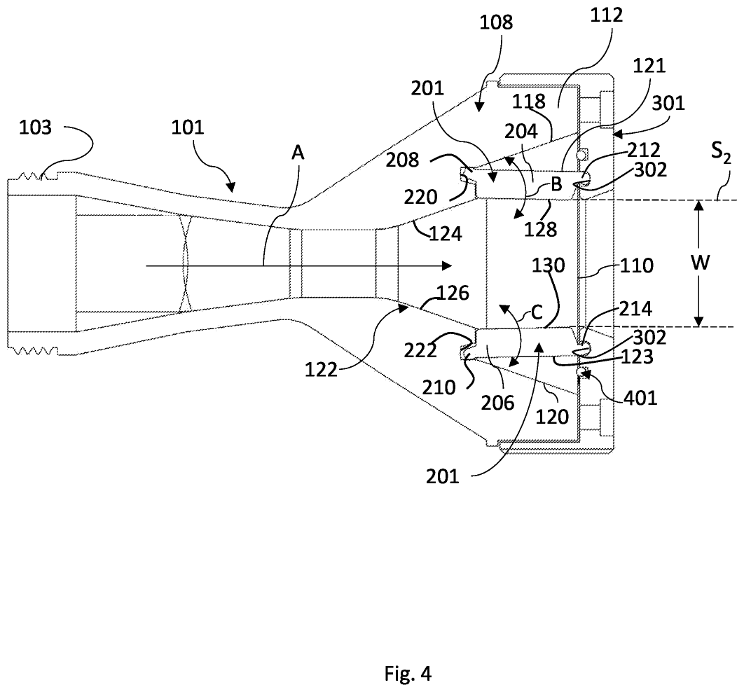

A shown in FIGS. 2, 3, and 4, in an embodiment the spray restrictor segment 201 includes at least a first spray adjustment arm 204 that is displaced by the actuator 301 toward (see FIG. 4) and away from (see FIG. 3) the center of the fluid flow path A in the direction of double-headed curved arrow B to vary the effective width W of the outlet opening 110. In an embodiment, the spray restrictor segment 201 includes a second spray adjustment arm 206 that is opposed to the first spray adjustment arm 204. In an embodiment, the first and second spray adjustment arms 204, 206 are displaced by the actuator 301 toward and away from the center of the fluid flow path A to vary the width W of the outlet opening 110. In a particular embodiment, the actuator 301 displaces the second spray adjustment arm 206 in the direction of double-heated curved arrow C. In an embodiment, the first and second spray adjustment arms 204, 206 are pivotally attached at upstream ends 208, 210, respectively, thereof to the outlet section 108.

As shown in FIGS. 4 and 5, in an embodiment, the outlet section 108 includes a terminal segment 112 having opposed planar, parallel top and bottom walls 114, 116, respectively, and first and second opposed planar side walls 118, 120, respectively. In an embodiment, the first and second opposed planar side walls 118, 120 are contiguous with the opposed top and bottom walls 114, 116, respectively, and in a particular embodiment, the first and second opposed planar side walls diverge from each other in a downstream direction. In an embodiment, the first and second spray adjustment arms 204, 206 are mounted in the terminal segment 112 to pivot toward and away from the first and second side walls 118, 120 along arcuate paths designated by arrows B and C, respectively, when displaced by the actuator ring 301.

In an embodiment, the actuator ring 301 is connected to the first and second spray adjustment arms 204, 206 to pivot the first and second spray adjustment arms relative to the terminal segment 112 to selectively vary the effective width W of the outlet opening 110. In embodiments, the effective width W of the outlet opening 110 is continuously adjustable by the actuator 301 between the configuration shown in FIG. 3, which is a maximum width outlet opening that provides a fluid stream flowing from the outlet opening having a maximum width, to the configuration shown in FIG. 4, which is a minimum width outlet opening that provides a fluid stream flowing from the outlet opening having a minimum width.

In an embodiment, the first and second spray adjustment arms 204, 206 are pivotally mounted at the upstream ends thereof to the first and second side walls 118, 120, respectively. And in an embodiment, the first and second spray adjustment arms 204, 206 are pivotally mounted at downstream ends 212, 214 thereof, respectively, to the actuator ring 301. In an embodiment, the actuator ring 301 is rotatably mounted on the nozzle body 102 such that rotation of the actuator ring relative to the nozzle body pivots the first and second spray adjustment arms 204, 206 toward and away from the first and second side walls 118, 120, respectively.

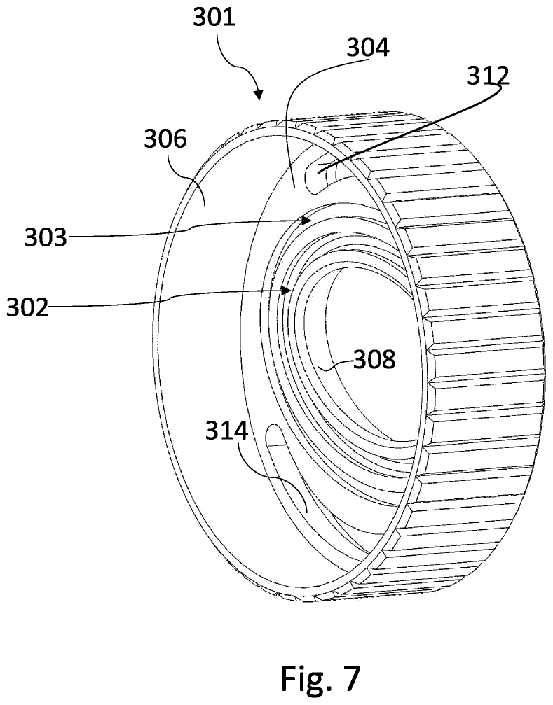

As shown in FIGS. 3, 4, and 7, in an embodiment, the first and second spray adjustment arms 204, 206 engage an eccentric groove 302 formed in the rear or upstream surface of the face 304 of the actuator ring 301 (see also FIGS. 1 and 2). Rotation of the actuator ring 301 relative to the outlet section 108 causes the eccentric groove 302 to move or rotate relative to the first and second spray adjustment arms 204, 206, about a center of the fluid flow path A, thereby pivoting the first and second spray adjustment arms toward and away from the first and second side walls 118, 120, respectively. In an exemplary embodiment, the spray adjustment arms 204, 206 include mating surfaces 121, 123, respectively, that fit flush with the first and second side walls 118, 120, respectively. In a particular embodiment, the surfaces of the first and second side walls 118, 120 and mating surfaces 121, 123 are flat and rectilinear.

In an embodiment, the first and second spray adjustment arms 204, 206 include first and second downstream cam tabs 212, 214, respectively (see also FIGS. 2 and 6), shaped to fit within the eccentric groove 302. In an embodiment, the upstream ends 208, 210 of the first and second spray adjustment arms 204, 206 include first and second upstream cam tabs 216, 218, respectively. The first and second side walls 118, 120 include first and second rounded sockets 220, 222, respectively, shaped to receive the first and second upstream cam tabs 216, 218, respectively, for pivotal movement of the first and second spray adjustment arms 204, 206, relative to the first and second side walls, respectively.

As shown in FIGS. 3, 4, and 5, in an embodiment, the outlet section 108 includes a divergent section 122 upstream of the spray restrictor segment 201. The divergent section 122 includes first and second opposed planar diverging side walls 124, 126, respectively. The first and second spray adjustment arms 204, 206 include first and second planar interior walls 128, 130 (see also FIG. 2) facing the center of the fluid flow path A, respectively. The first and second interior walls 128, 130 are adjacent the first and second diverging side walls 124, 126. The first and second interior walls 128, 130 cooperate with the diverging side walls 124, 126 and the interior walls of the inlet section 104 to provide a fluid flow path A that is defined by smooth, continuous walls without obstructions protruding into the fluid flow path that extends from the inlet opening 106 to the outlet opening 110. This design minimizes turbulence of the fluid within the fluid flow path A to provide a pattern of spray S₁, S₂ from the outlet opening 110 having a more uniform height H across its width W.

As shown in FIG. 5, an embodiment, the divergent section 122 includes opposed planar top and bottom walls 132, 134, respectively. The planar top and bottom walls 132, 134 are contiguous with the first and second planar diverging side walls 124, 126, respectively and therefore are themselves diverging in a downstream width dimension. In an embodiment, the planar top and bottom walls 132, 134 terminate adjacent the first and second spray adjustment arms 204, 206 at an upstream end of the terminal segment 112. In an embodiment, the planar top and bottom walls 132, 134 converge toward each other in a downstream fluid flow direction, making an angle θ with the planes of the parallel top and bottom walls 114, 116 of the terminal segment 112.

In an exemplary embodiment, the disclosed adjustable nozzle 101 includes a nozzle body 102 having an inlet section 104 with an inlet opening 106 and an outlet section 108 with an outlet opening 110. The outlet section 108 includes a terminal segment 112 having opposed planar, parallel top and bottom walls 114, 116 and first and second opposed planar side walls 118, 120 contiguous with the top and bottom walls. The top and bottom walls 114, 116 are greater in width than the first and second side walls 118, 120 such that the outlet opening 110 is oblong. A fluid flow path A extends from the inlet opening 106 to the outlet opening 110 such that fluid exits the outlet opening in a rectangular stream S₁, S₂.

First and second opposed spray adjustment arms 204, 206 are attached to the outlet section 108 and are extendable into the fluid flow path A. The spray adjustment arms 204, 206 each have a planar body terminating in an upstream cam tab 216, 218 and a downstream cam tab 212, 214 and having planar interior walls 128, 130 forming a rectilinear surface facing a center of the fluid flow path A. The upstream cam tabs 216, 218 are received for pivotal movement of the first and second spray adjustment arms 204, 206 in the first and second sockets 220, 222 formed in the first and second side walls 118, 120, respectively.

An actuator ring 301 is rotatably mounted on an end of the nozzle body 102. The actuator ring 301 has an elliptical groove 302 concentric with a center of the fluid flow path A. The elliptical groove 302 receives the downstream cam tabs 212, 214 of the spray adjustment arms 204, 206 such that rotation of the actuator ring relative to the outlet section 108 end of the nozzle body 102 pivots the spray adjustment arms toward and away from the center of the fluid flow path A, thereby varying a width of the rectangular stream of fluid from the outlet opening.

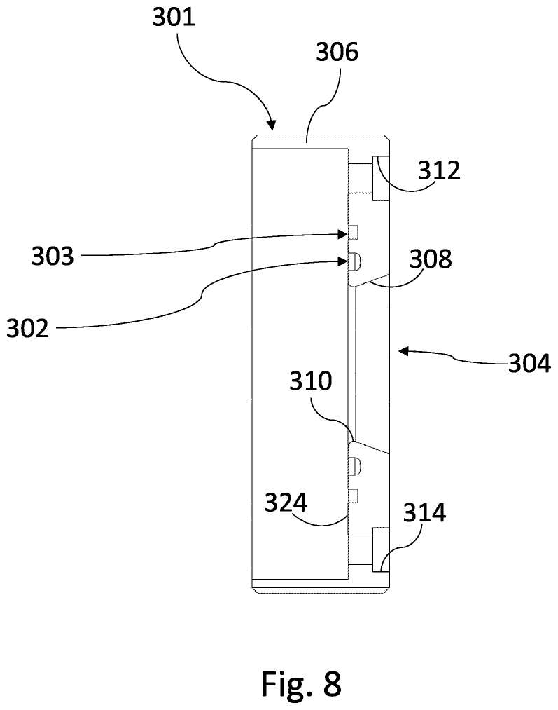

The actuator ring 301 may take many forms. In embodiments shown in FIGS. 1, 2, and 8, the actuator ring 301 includes a knurled annular side wall 306 contiguous with the face 304 to form a cup shape. the face includes an elliptical opening 308 sized to provide clearance for the outlet opening 110. The inner periphery 310 of the elliptical opening is shaped to align with downstream faces 224, 226 of the spray adjustment arms 204, 206 (see also FIG. 6). In an embodiment, the face 304 includes opposing arcuate countersunk slots 312, 314 extending therethrough that receive threaded retention studs 316, 318 that thread into holes 320, 322 formed in the flat, circular downstream face 136, which is sized to seat the flat, upstream side 324 of the face 304 of the actuator 301, together forming a retention system 501. In an embodiment, the spray retention arms 204, 206 are shaped such that the downstream cam tabs 212, 214 protrude through the outlet opening 110 from the downstream face 136 and into the elliptical groove 302 of the actuator ring 301, as shown in FIGS. 3 and 4.

In an embodiment, the upstream side 324 includes an elliptical groove 303 that receives a resilient elliptical gasket 401 to seal the actuator 301 against the downstream face 136 and provide resistance to relative rotational movement between the nozzle body 102 and the actuator ring 301. The elliptical groove 303 that receives gasket 401 and the elliptical groove 302 that receives the downstream cam tabs 212, 214 are concentric on the upstream side 324 of the face 304 of the actuator ring 301. In an embodiment, the retention studs 316, 318 hold the actuator ring 301 against the outlet section 108 so that the radially inner surface of the side wall 306 overlies and is concentric with the annular side wall 138 of the outlet section 108 but allows rotation of the actuator relative to the outlet section. In an embodiment, the slots 312, 314 define limits of rotation of the actuator 301 relative to the outlet section 108 and are selected with the elliptical groove 302 to coincide with maximum and minimum pivoting movement of the spray adjustment arms 204, 206 to vary the width W of the outlet opening 110.

In an embodiment, the shape (eccentricity) of the elliptical groove 302 is selected and is formed on the upstream side 324 of the face 304 of the actuator ring 301 such that when the major axis of the elliptical groove 302 is parallel to the width W of the outlet opening 110, the spray adjustment arms 204, 206 are pivoted to a maximum divergence angle, as shown in FIG. 3, resulting in a spray S₁ of maximum width. When the actuator ring 301 is rotated so that the major axis of the elliptical groove 302 is perpendicular to the width W of the of the nozzle outlet opening 110, in which it is parallel to the height H of the outlet opening, the spray adjustment arms 204, 206 are pivoted to a minimum divergence angle, as shown in FIG. 4, resulting in a spray S₂ of minimum width. Because the height H is not affected by the rotation of the actuator ring 301 and the resultant pivoting of the spray adjustment arms 204, 206, the height does not change between maximum spray S₁ and minimum spray S₂.

In an embodiment, a method of varying a width of an oblong stream S₁, S₂ of fluid exiting an oblong outlet opening 110 in the outlet section 108 of the nozzle body 102 includes actuating an actuator in the form of an actuator ring 301 in the outlet section to displace the spray restrictor segment 201 toward and away from the center of the fluid flow path A to vary an effective width W of the oblong outlet opening 110, thereby varying the width of the rectangular stream S₁, S₂ of fluid exiting the oblong outlet opening.

In an embodiment, actuating the actuator ring 301 to displace the spray restrictor segment 201 includes pivoting first and second opposed spray adjustment arms 204, 206 attached to the outlet section 108 and extending into the fluid flow path A toward and away from the center of the fluid flow path, thereby varying the effective width W of the oblong outlet opening 110 to vary the width of the oblong stream S₁, S₂ of fluid from the outlet opening. In an embodiment, actuating the actuator ring 301 to displace the spray restrictor segment 201 includes rotating an actuator ring 301 rotatably attached to the nozzle body 102 to pivot the first and second opposed spray adjustment arms 204, 206 toward and away from the center of the fluid flow path A.

The disclosed embodiments of the adjustable nozzle 101 provide a robust nozzle system that is easily adjustable by a user simply by grasping the actuator ring 301 and rotating it relative to the nozzle body 102 to vary the effective width W of the outlet opening 110 and thereby vary the width of the stream S₁, S₂ from the outlet opening. The smooth walls of the interior of the nozzle body 102, combined with the rectangular outlet opening 110 provide a flat stream S₁, S₂ that is uniform across its width and provides a maximum throw for a given fluid pressure.

While the forms of apparatus and methods disclosed herein constitute preferred embodiments of the adjustable nozzle, it is to be understood that the invention is not limited to these precise forms of apparatus and methods, and that changes may be made therein without departing from the scope of the invention.

What is claimed is:

1. An adjustable nozzle, comprising:
a nozzle body having an inlet section with an inlet opening, an outlet section with an outlet opening, and a fluid flow path extending from the inlet opening to the outlet opening;
a spray restrictor segment located in the outlet section; and
an actuator that displaces the spray restrictor segment toward and away from a center of the fluid flow path, thereby varying a pattern of fluid flowing from the fluid flow path through the outlet opening.

2. The adjustable nozzle of claim 1, wherein the outlet opening is oblong in shape having a width and a height; and the actuator displaces the spray restrictor segment toward and away from the center of the fluid flow path to vary the width of the outlet opening.

3. The adjustable nozzle of claim 2, wherein the spray restrictor segment has a thickness that equals the height of the outlet opening.

4. The adjustable nozzle of claim 3, wherein the spray restrictor segment includes at least a first spray adjustment arm that is displaced by the actuator toward and away from the center of the fluid flow path to vary the width of the outlet opening.

5. The adjustable nozzle of claim 4, wherein the spray restrictor segment includes a second spray adjustment arm that is opposed to the first spray adjustment arm; and the first and second spray adjustment arms are displaced by the actuator toward and away from the center of the fluid flow path to vary the width of the outlet opening.

6. The adjustable nozzle of claim 5, wherein the first and second spray adjustment arms are pivotally attached at upstream ends thereof to the outlet section.

7. The adjustable nozzle of claim 6, wherein the outlet section includes a terminal segment having opposed planar, parallel top and bottom walls and first and second opposed planar side walls contiguous with the top and bottom walls; and wherein the first and second spray adjustment arms are mounted in the terminal segment to pivot toward and away from the first and second side walls, respectively, when displaced by the actuator.

8. The adjustable nozzle of claim 7, wherein the actuator is connected to the first and second spray adjustment arms to pivot the first and second spray adjustment arms relative to the terminal segment to selectively vary an effective width of the outlet opening.

9. The adjustable nozzle of claim 8, wherein the first and second spray adjustment arms are pivotally mounted at the upstream ends thereof to the first and second side walls, respectively.

10. The adjustable nozzle of claim 9, wherein the first and second spray adjustment arms are pivotally mounted at downstream ends thereof to the actuator.

11. The adjustable nozzle of claim 10, wherein the actuator is rotatably mounted on the nozzle body such that rotation of the actuator relative to the nozzle body pivots the first and second spray adjustment arms toward and away from the first and second side walls, respectively.

12. The adjustable nozzle of claim 11, wherein the first and second spray adjustment arms engage an eccentric groove formed in the actuator, such that the rotation of the actuator causes the eccentric groove to move relative to the first and second spray adjustment arms, thereby pivoting the first and second spray adjustment arms toward and away from the first and second side walls, respectively.

13. The adjustable nozzle of claim 12, wherein the first and second spray adjustment arms include first and second downstream cam tabs, respectively, shaped to fit within the eccentric groove.

14. The adjustable nozzle of claim 13, wherein the first and second spray adjustment arms include first and second upstream cam tabs, respectively, and the first and second side walls include first and second sockets shaped to receive the first and second upstream cam tabs, respectively, for pivotal movement of the first and second spray adjustment arms relative to the first and second side walls, respectively.

15. The adjustable nozzle of claim 5, further comprising a divergent section upstream of the outlet section, the divergent section having first and second opposed planar diverging side walls;
and the first and second spray adjustment arms include first and second planar interior walls facing the center of the fluid flow path, respectively; wherein the first and second interior walls are adjacent the first and second diverging side walls.

16. The adjustable nozzle of claim 15, wherein the divergent section includes opposed planar top and bottom walls contiguous with the first and second planar diverging side walls, the top and bottom walls terminating adjacent the first and second spray adjustment arms at an upstream end of the terminal segment.

17. An adjustable nozzle, comprising:
a nozzle body having an inlet section with an inlet opening, an outlet section with an outlet opening, the outlet section including a terminal segment having opposed planar, parallel top and bottom walls and first and second opposed planar side walls contiguous with the top and bottom walls, wherein the top and bottom walls are greater in length than the first and second side walls such that the outlet opening is oblong, and a fluid flow path extending from the inlet opening to the outlet opening such that fluid exits the outlet opening in a rectangular stream;
first and second opposed spray adjustment arms attached to the outlet section and extendable into the fluid flow path, the spray adjustment arms each having a planar body terminating in an upstream cam tab and a downstream cam tab and having a rectilinear edge facing a center of the fluid flow path, the upstream cam tabs being received for pivotal movement of the first and second spray adjustment arms in first and second sockets formed in the first and second side walls, respectively; and
an actuator ring rotatably mounted on an end of the nozzle body, the actuator ring having an elliptical groove concentric with a center of the fluid flow path that receives the downstream cam tabs attached to the spray adjustment arms such that rotation of the actuator ring relative to the end of the nozzle body pivots the spray adjustment arms toward and away from the center of the fluid flow path, thereby varying a width of the rectangular stream of fluid from the outlet opening.

18. A method of varying a width of an oblong stream of fluid exiting an oblong outlet opening in an outlet section of a nozzle body, the method comprising:
actuating an actuator in the outlet section to displace a spray restrictor segment toward and away from a center of the fluid flow path to vary an effective width of the oblong outlet opening, thereby varying the width of the oblong stream of fluid exiting the outlet opening.

19. The method of claim 18, wherein actuating the actuator to displace the spray restrictor segment includes pivoting first and second opposed spray adjustment arms attached to the outlet section and extending into the fluid flow path toward and away from the center of the fluid flow path, thereby varying the effective width of the oblong outlet opening to vary the width of the rectangular stream of fluid from the outlet opening.

20. The method of claim 19, wherein actuating the actuator to displace the spray restrictor segment includes rotating an actuator ring rotatably attached to the nozzle body to pivot the first and second opposed spray adjustment arms toward and away from the center of the fluid flow path.
